(19) United States
(12) Patent Application Publication
(10) Pub. No.: US 2026/0147702 A1
(43) Pub. Date: May 28, 2026

(54) DETECTING SIMULATION CYCLE COUNT CHANGES

(71) Applicant: INTERNATIONAL BUSINESS MACHINES CORPORATION, Armonk, NY (US)

(72) Inventors: Katherine Jessica Seggerman, Poughkeepsie, NY (US); Kevin Calabrese, New Paltz, NY (US)

(21) Appl. No.: 18/957,141

(22) Filed: Nov. 22, 2024

(51) Int. Cl. G06F 11/3698

(52) U.S. Cl. CPC G06F 11/3698

(57) ABSTRACT

A first average simulation cycle count for running each of a plurality of unique testcases in a first system state can be determined. A second average simulation cycle count for running each of the plurality of unique testcases in a second system state can be determined. For each of the plurality of unique testcases, a simulation cycle count difference can be determined by comparing the first average simulation cycle count to the second average simulation cycle count. For each of the plurality of unique testcases for which the simulation cycle count difference exceeds a threshold value, an identifier for the unique testcase and the simulation cycle count difference for the unique testcase can be output.

### BACKGROUND

The present invention relates to system validation, and more specifically, to use of testcases.

A testcase is a set of conditions or variables under which a tester will determine whether a system under test satisfies requirements or works correctly. A testcase may be in the form of a document that includes a set of test data, preconditions, expected results and postconditions, developed for a particular test scenario in order to verify compliance against a specific requirement.

### SUMMARY

A method can include determining, using a processor, a first average simulation cycle count for running each of a plurality of unique testcases in a first system state. The method also can include determining a second average simulation cycle count for running each of the plurality of unique testcases in a second system state. The method also can include, for each of the plurality of unique testcases, determining a simulation cycle count difference by comparing the first average simulation cycle count to the second average simulation cycle count. The method also can include, for each of the plurality of unique testcases for which the simulation cycle count difference exceeds a threshold value, outputting an identifier for the unique testcase and the simulation cycle count difference for the unique testcase.

A computer system includes a processor set, one or more computer-readable storage media, and program instructions stored on the one or more storage media to cause the processor set to perform operations. The operations can include determining a first average simulation cycle count for running each of a plurality of unique testcases in a first system state. The operations also can include determining a second average simulation cycle count for running each of the plurality of unique testcases in a second system state. The operations also can include, for each of the plurality of unique testcases, determining a simulation cycle count difference by comparing the first average simulation cycle count to the second average simulation cycle count. The operations also can include, for each of the plurality of unique testcases for which the simulation cycle count difference exceeds a threshold value, outputting an identifier for the unique testcase and the simulation cycle count difference for the unique testcase.

A computer program product includes one or more computer-readable storage media and program instructions stored on the one or more storage media to perform operations. The operations can include determining a first average simulation cycle count for running each of a plurality of unique testcases in a first system state. The operations also can include determining a second average simulation cycle count for running each of the plurality of unique testcases in a second system state. The operations also can include, for each of the plurality of unique testcases, determining a simulation cycle count difference by comparing the first average simulation cycle count to the second average simulation cycle count. The operations also can include, for each of the plurality of unique testcases for which the simulation cycle count difference exceeds a threshold value, outputting an identifier for the unique testcase and the simulation cycle count difference for the unique testcase.

This Summary section is provided merely to introduce certain concepts and not to identify any key or essential features of the claimed subject matter. Other features of the inventive arrangements will be apparent from the accompanying drawings and from the following detailed description.

### BRIEF DESCRIPTION OF THE DRAWINGS

FIG. 1 is a block diagram illustrating an example of a network data processing system.

FIG. 2 is a block diagram illustrating example architecture for testing a system under test.

FIG. 3 is a flowchart illustrating an example of a method of detecting simulation cycle count changes.

### DETAILED DESCRIPTION

This disclosure relates to system validation and, more particularly, to use of testcases. In this regard, the arrangements described herein are directed to computer technology, and provide an improvement to computer technology. Specifically, the present arrangements improve detection of logic and simulation changes that cause degradation in testcase performance.

In random simulation of a system, testcase max cycle counts typically are set to values that are higher than an average testcase in order to account for the longest passing corner case of simulation runs. This allows the average time for a testcase run to transparently creep longer, however, without detection. This can result in performance degradation due to logic or computing environment changes to go undetected during random simulation, which is undesirable.

The arrangements described herein address these deficiencies by enabling early detection of logic and simulation changes that cause changes in testcase performance. Changes in testcase performance can include, for example, performance degradation due to a mainline regression and/or inefficiencies introduced by logic changes, simulation changes and/or changes in the computing environment. These arrangements also can provide data for validating that a change has increased the performance of particular testcases. To accomplish those improvements, the present arrangements provide early detection of testcase run maximum cycle count creep by comparing, between model release tags, an average of simulation cycle counts of unique testcases. Only passing testcases are used to calculate the average simulation cycle count, which avoids skews that may be influenced by testcase failures. A minimum threshold of testcases to be sampled can be specified for use in calculating the average of simulation cycle counts. Further, a minimum percentage of cycle count can be specified as a change threshold, which can be used to flag for testcase cycle count deviation.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer-readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer-readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as testcase cycle count detector 200. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

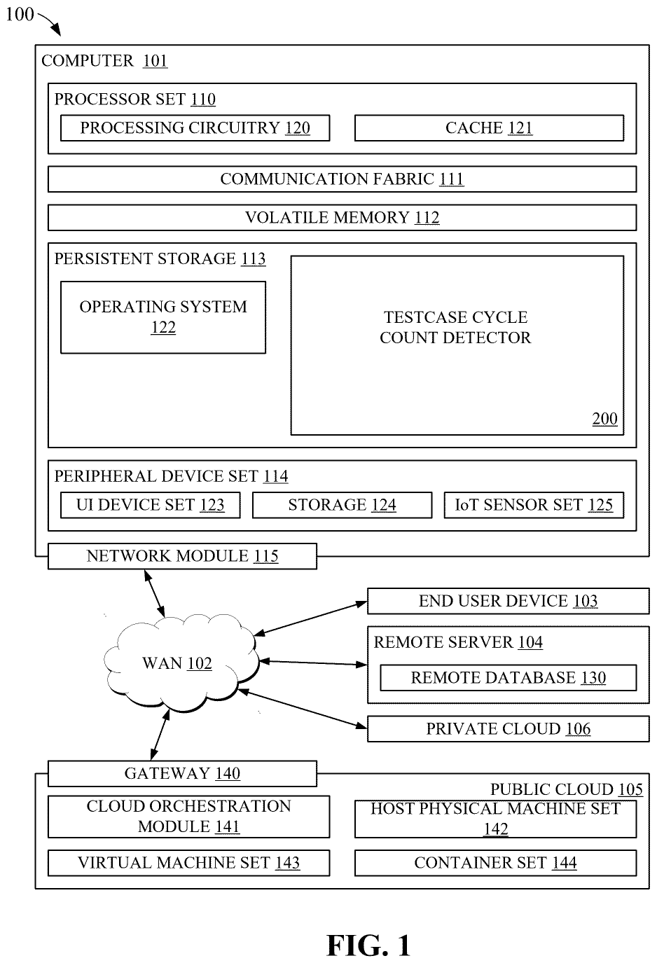

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer-readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer-readable program instructions are stored in various types of computer-readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer, and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer-readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 012 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

CLOUD COMPUTING SERVICES AND/OR MICROSERVICES (not separately shown in FIG. 1): private and public clouds 106 are programmed and configured to deliver cloud computing services and/or microservices (unless otherwise indicated, the word “microservices” shall be interpreted as inclusive of larger “services” regardless of size). Cloud services are infrastructure, platforms, or software that are typically hosted by third-party providers and made available to users through the internet. Cloud services facilitate the flow of user data from front-end clients (for example, user-side servers, tablets, desktops, laptops), through the internet, to the provider's systems, and back. In some embodiments, cloud services may be configured and orchestrated according to as “as a service” technology paradigm where something is being presented to an internal or external customer in the form of a cloud computing service. As-a-Service offerings typically provide endpoints with which various customers interface. These endpoints are typically based on a set of APIs. One category of as-a-service offering is Platform as a Service (PaaS), where a service provider provisions, instantiates, runs, and manages a modular bundle of code that customers can use to instantiate a computing platform and one or more applications, without the complexity of building and maintaining the infrastructure typically associated with these things. Another category is Software as a Service (SaaS) where software is centrally hosted and allocated on a subscription basis. SaaS is also known as on-demand software, web-based software, or web-hosted software. Four technological sub-fields involved in cloud services are: deployment, integration, on demand, and virtual private networks.

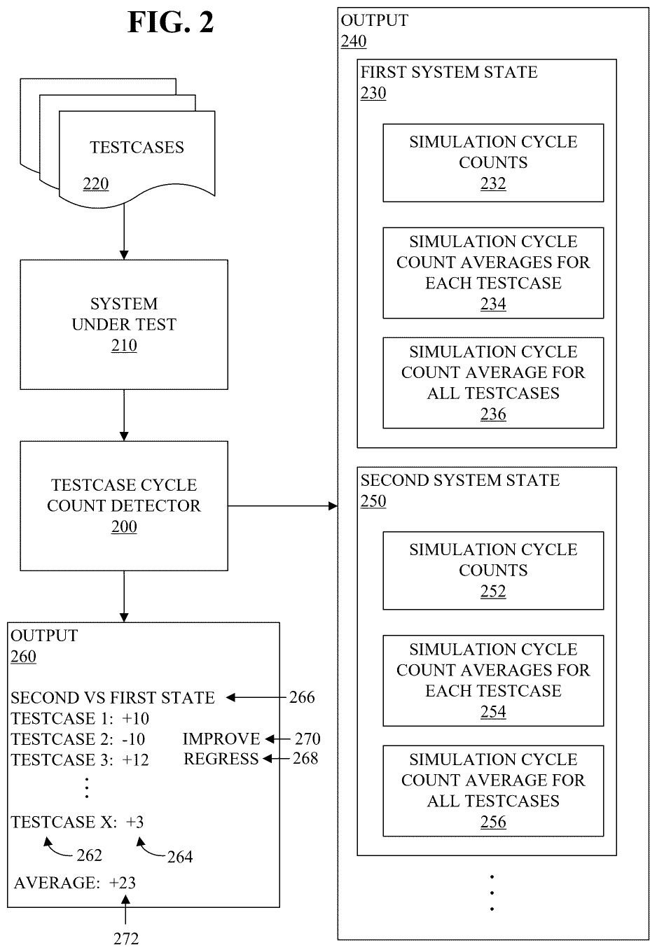

FIG. 2 is a block diagram illustrating example architecture for testing a system under test 210. System under test 210 can be hardware and/or software. In illustration, system under test 210 can be a microprocessor or a microprocessor model ran in a microprocessor simulator. In another example system under test 210 can be computer software.

Testcase cycle count detector 200 can be communicatively linked to system under test 210, or can be executed by system under test 210. In an arrangement in which system under test 210 is a microprocessor model ran in a microprocessor simulator, testcase cycle count detector can be executed by the microprocessor simulator. Testcase cycle count detector 200 can be, for example, script code, though the present arrangements are not limited in this regard.

Testcase cycle count detector 200 can monitor various parameters of system under test 210 while a plurality of unique testcases 220 are ran on system under test 210. Testcases 220 can be configured to simulate various computing loads on system under test 210. The monitored parameters of system under test 210 include, but are not limited to, a number of clock cycles used for each run of each a unique testcase 220 and a duration of simulation cycle count used for each run of each a unique testcase 220.

Testcase cycle count detector 200 can be implemented between model release tags, and can be used for early detection of time creep in running testcases 220 resulting from changes made to system under test 210, for example during development of a new or next release of system under test 210. Further, testcase cycle count detector 200 can determine a maximum time creep.

In illustration, in a first system state 230 of system under test 210, testcases 220 can be ran on system under test 210. Testcase cycle count detector 200 can determine a simulation cycle count for running each of the plurality of testcases 220 on system under test 210. In one or more arrangements, one or more testcases 220 can be ran multiple times on system under test 210 while system under test 210 is in a particular state, which can be useful for reflecting the performance of performance related structures of system under test 210 after the performance related structures are warmed up (e.g., branch prediction has been sufficiently trained, caches are sufficiently pre-loaded with data, etc.).

For each run of a unique testcase 220, testcase cycle count detector 200 can determine a simulation cycle count 232 for that run. In one or more non-limiting arrangements, testcase cycle count detector 200 need only determine simulation cycle count 232 for unique testcases 220 that pass simulation testing. Testcase cycle count detector 200 can disregard simulation cycle count data for testcases 220 that do not pass simulation testing and/or for testcase runs that do not pass simulation testing.

If a unique testcase 220 is ran multiple times while the system under test 210 is in the first system state, testcase cycle count detector 200 can determine an average (e.g., a mean average) simulation cycle count 234 for the multiple runs of that unique testcase 220. Optionally, testcase cycle count detector 200 can determine an average simulation cycle count 236 for a plurality of testcases 220 ran on system under test 210 while system under test 210 is in the first system state 230. For example, testcase cycle count detector 200 can determine an average simulation cycle count 236 for at least a threshold number of unique testcases 220. The threshold number of unique testcases 220 can be a user specified value. In another example, testcase cycle count detector 200 can determine an average simulation cycle count 236 for all runs of all testcases 220 ran on system under test 210 while system under test 210 is in the first system state 230.

Testcase cycle count detector 200 can output the determined simulation cycle counts 232 and average simulation cycle counts 234, 236 for the first system state 230, along with an identifier that associates those parameters with the first system state, as output 240. Output 240 can be stored, for example to persistent storage 113, and/or communicated to another system, for example to end user device 103 and/or remote server 104.

In a next state of system under test 210, for example a second system state 250 resulting from a change in a design and/or a configuration of the system under test 210, testcases 220 again can be ran on system under test 210 and testcase cycle count detector 200 can reiterate the process of generating output 240, but this time for second system state 250. Testcase cycle count detector 200 again can determine a simulation cycle count 252 for running each of the plurality of unique testcases 220 on system under test 210. Testcase cycle count detector 200 also can determine an average simulation cycle count 254 for unique testcases 220 that are run multiple times while system under test 210 is in the next state and, optionally, determine an average simulation cycle count 256 for testcases 220 ran on system under test 210 while system under test 210 is in the next state 250. Testcase cycle count detector 200 can output the determined simulation cycle counts 252 and average simulation cycle counts 254, 256 for the next state, along with an identifier that associates those parameters with the next state, as output 240.

Testcase cycle count detector 200 can compare simulation cycle counts 252 determined for second system state 250 to simulation cycle counts 232 determined for first system state 230, compare simulation cycle count averages for each testcase 254 determined for second system state 250 to simulation cycle count averages for each testcase 234 determined for first system state 230, compare simulation cycle count average for all testcases 256 determined for second system state 250 to simulation cycle count average for all testcases 236 determined for first system state 230, etc. Based on such comparisons, testcase cycle count detector 200 can generate output 260.

Output 260 generated by testcase cycle count detector 200 can include, for example, a testcase identifier 262 indicating each testcase 220 and, for each testcase 220, a simulation cycle count difference 264 indicating a change in the simulation cycle count for that testcase the second system state 250 as compared to the simulation cycle count for that testcase the first system state 230. Simulation cycle count differences 264 that have a positive value indicate a time creep. Output 260 also can include an identifier 266 indicating which states 230, 250 were used for the comparisons.

In one or more arrangements, the simulation cycle count difference 264 for a testcase 220 can be determined from a single run of that testcase 220 in the first system state 230 and a single run of that testcase 220 in the second system state 250 based on comparing simulation cycle counts 232, 252 for that testcase 220.

In one or more arrangements, the simulation cycle count difference 264 for a testcase 220 can be determined from a plurality of runs of that testcase 220 in the first system state 230 and a plurality of runs of that testcase 220 in the second system state 250 based on comparing simulation cycle counts 232, 252 for that testcase 220. For a particular unique testcase 220, the simulation cycle count 252 for the first run of that testcase 220 in the second system state 250 can be compared the simulation cycle count 232 for the first run of that testcase 220 in the first system state 230, the simulation cycle count 252 for the second run of that testcase 220 in the second system state 250 can be compared the simulation cycle count 232 for the second run of that testcase 220 in the first system state 230, and so on. The simulation cycle count difference 264 for that testcase can be determined from the comparison resulting in the greatest simulation cycle count difference 264. In the case that the greatest simulation cycle count difference 264 is a positive value, that simulation cycle count difference 264 can be considered to be a maximum time creep for that testcase 220.

In one or more arrangements, the simulation cycle count difference 264 for a testcase 220 can be determined from a simulation cycle count average of a plurality of runs of that testcase 220 in the first system state 230 and a simulation cycle count average of a plurality of runs of that testcase 220 in the second system state 250 based on comparing simulation cycle count averages 234, 254 for that testcase 220.

In one or more arrangements, rather than outputting a testcase identifier 262 and a simulation cycle count difference 264 for each testcase 220, output 260 can include only a testcase identifier 262 and a simulation cycle count difference 264 for each testcase 220 for which the simulation cycle count difference 264 exceeds a threshold value, or for which an absolute value of the simulation cycle count difference 264 exceeds a threshold value. The threshold value can be user specified.

In one or more arrangements, a simulation cycle count difference 264 that exceeds the threshold value can be an indicator that a system regression has occurred between the first system state 230 and the second system state 250, and that regression negatively affects the testcase 220 represented by the testcase identifier 262 to which that simulation cycle count difference 264 is assigned. In one or more arrangements, output 260 can include a regression indicator 268 for each testcase identifier 262 for which the simulation cycle count difference 264 exceeds the threshold value. Regression indicator 268 can indicate that a system regression has occurred between the first system state 230 and the second system state 250, and the regression negatively affects the testcase 220, represented by the testcase identifier 262, to which that regression indicator 268 is assigned. In one or more arrangements, output 260 can include an improvement indicator 270 for each testcase identifier 262 for which the simulation cycle count difference 264 is less than or equal to the threshold value. Improvement indicator 270 can indicate that a system improvement has occurred between the first system state 230 and the second system state 250, and that improvement positively affects the testcase 220, represented by the testcase identifier 262, to which that improvement indicator 270 is assigned.

In one or more arrangements, testcase cycle count detector 200 can compare simulation cycle count averages for all testcases 256 for second system state 250 to simulation cycle count averages for all testcases 236 for first system state 230. Based on that comparison, testcase cycle count detector 200 can output an average simulation cycle count difference 272 indicating a difference between simulation cycle count averages for all testcases 256 for second system state 250 and simulation cycle count averages for all testcases 236 for first system state 230.

Testcase cycle count detector 200 can iterate the processes described for each new system state, for system under test 210, for which testcases 220 are ran. Output 240 generated for each new system state can be compared to output 240 generated for one or more previous system states 230, 250, and corresponding output 260 can be generated by testcase cycle count detector 200. For example, testcase cycle count detector 200 can compare output 240 for a third system state to output 240 for second system state 250 and generate corresponding output 260. Further, testcase cycle count detector 200 can compare output 240 for the third system state to output 240 for first system state 230 and generate corresponding output 260.

In one or more arrangements, testcase cycle count detector 200 can detect unexpected computing environment issues and logic bugs. In illustration, testcase cycle count detector 200 can determine that unexpected computing environment issues and logic bugs exist based on determining a simulation cycle count difference 264 that exceeds a threshold value. Further, testcase cycle count detector 200 can identify and flag numerous changes in a computing environment that impact test results, such as changes that cause the simulation cycle count difference 264 to exceed the threshold value.

Responsive to detecting an unexpected computing environment issue and/or logic bug, testcase cycle count detector 200 can output a failure indicator. The failure indicator can indicate which testcase(s) 220 triggered the computing environment issue and/or logic bug (e.g., testcase(s) 220 for which the cycle count difference 264 exceeds the threshold value), the number of testcases 220 ran for the system state 250 in which the unexpected computing environment issue and/or logic bug is detected, the cycle count difference 264 for each of the indicated testcase(s) 220 that triggered the computing environment issue and/or logic bug, and/or a percentage value indicating the cycle count difference 264, for each testcase 220 that triggered the computing environment issue and/or logic bug, as a percentage change with respect to a previous simulation cycle count 232 for that testcase 220. Testcase cycle count detector 200 can present the failure indicator to a user, such as a testcase owner, for example via a user interface of computer 101 or a user interface of end user device 103. Responsive to perusing the failure indicator, the user can compare contents of system under test 210 in a present system state 250 to contents of system under test 210 in a previous system state 230 based on a type of the testcase(s) 220 that triggered the failure indicator. Further, in the case that system under test 210 includes software, testcase cycle count detector 200 can be configured to filter each unit or element of that software based on logic paths, simulation types and/or testcases 220 using a directory structure. Accordingly, users can inspect logic paths correlating to an unexpected computing environment issue and/or logic bug to quickly identify changes that may have caused the issue.

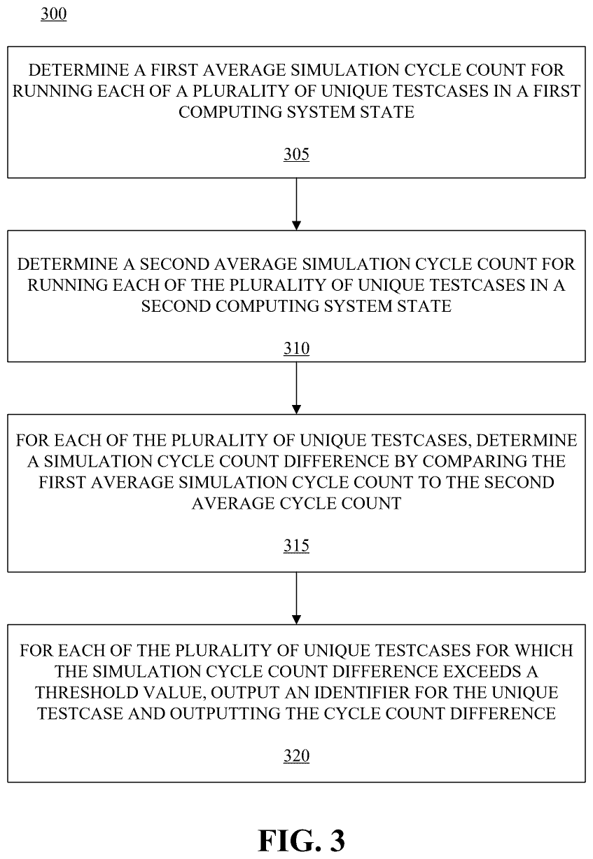

FIG. 3 is a flowchart illustrating an example of a method 300 of detecting simulation cycle count changes. Method 300 can be implemented by testcase cycle count detector 200.

At step 305, testcase cycle count detector 200 can determine a first average simulation cycle count for running each of a plurality of unique testcases in a first system state.

At step 310 testcase cycle count detector 200 can determine a second average simulation cycle count for running each of the plurality of unique testcases in a second system state.

At step 315, testcase cycle count detector 200 can, for each of the plurality of unique testcases, determine a simulation cycle count difference by comparing the first average simulation cycle count to the second average simulation cycle count.

At step 320, testcase cycle count detector 200 can, for each of the plurality of unique testcases for which the simulation cycle count difference exceeds a threshold value, output an identifier for the unique testcase and outputting the cycle count difference.

It will be understood that, although the terms first, second, etc. may be used herein to describe various elements, these elements and steps should not be limited by these terms, as these terms are only used to distinguish one element from another. In illustration, testcase cycle count detector 200 can detect simulation cycle counts for many system states. A particular simulation cycle count can be selected as a first simulation cycle count, even if that simulation cycle count does not occur first in a chronological order, and that simulation cycle count's corresponding system state can be identified as the first system state. Further, another simulation cycle count can be selected as a second simulation cycle count, even if that simulation cycle count does not occur immediately after the simulation cycle count that is selected as the first simulation cycle count. Similarly, the system state corresponding to the simulation cycle count selected as the second simulation cycle count can be identified as a second system state.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

Several definitions that apply throughout this document will now be presented.

As defined herein, the term “simulation cycle count” means a total number of steps taken during a simulation run of a testcase.

As defined herein, the term “time creep” means an increase in a duration of time used to run a testcase due to a change in state of a system under test. The change in state of the system under test can result from a change in a design and/or a configuration of the system under test.

As defined herein, the term “maximum time creep” means a maximum value of time creep. For example, maximum time creep can be a value of time creep that is highest among a plurality of time creeps determined by running a plurality of unique testcases.

As defined herein, the term “responsive to” means responding or reacting readily to an action or event. Thus, if a second action is performed “responsive to” a first action, there is a causal relationship between an occurrence of the first action and an occurrence of the second action, and the term “responsive to” indicates such causal relationship.

As defined herein, the term “output” means storing in memory elements, writing to display or other peripheral output device, sending or transmitting to another system, exporting, or similar operations.

As defined herein, the term “automatically” means without user intervention.

As defined herein, the term “user” means a person (i.e., a human being).

What is claimed is:

1. A computer-implemented method, comprising:
determining, using a processor, a first average simulation cycle count for running each of a plurality of unique testcases in a first system state;
determining a second average simulation cycle count for running each of the plurality of unique testcases in a second system state;
for each of the plurality of unique testcases, determining a simulation cycle count difference by comparing the first average simulation cycle count to the second average simulation cycle count; and
for each of the plurality of unique testcases for which the simulation cycle count difference exceeds a threshold value, outputting an identifier for the unique testcase and the simulation cycle count difference for the unique testcase.

2. The method of claim 1, further comprising:
for each of the plurality of unique testcases for which the second average simulation cycle count exceeds the first average simulation cycle count by the threshold value, outputting an indicator indicating that a system regression has occurred between the first system state and the second system state.

3. The method of claim 1, further comprising:
for each of the plurality of unique testcases for which the first average simulation cycle count exceeds the second average simulation cycle count by the threshold value, outputting an indicator indicating that a system performance improvement has occurred between the first system state and the second system state.

4. The method of claim 1, wherein the first system state and the second system state are system states between model release tags.

5. The method of claim 1, wherein the determining the simulation cycle count difference by comparing the first average simulation cycle count to the second average simulation cycle count comprises:
comparing the first average simulation cycle count to the second average simulation cycle count only for unique testcases that pass simulation testing.

6. The method of claim 1, wherein the determining the simulation cycle count difference by comparing the first average simulation cycle count to the second average simulation cycle count comprises:
comparing the first average simulation cycle count to the second average simulation cycle count for at least a specified threshold number of unique testcases.

7. The method of claim 1, wherein the threshold value for the simulation cycle count difference is a user specified threshold value.

8. A computer system, comprising:
a processor set;
one or more computer-readable storage media; and
program instructions stored on the one or more storage media to cause the processor set to perform operations comprising:
determining a first average simulation cycle count for running each of a plurality of unique testcases in a first system state;
determining a second average simulation cycle count for running each of the plurality of unique testcases in a second system state;
for each of the plurality of unique testcases, determining a simulation cycle count difference by comparing the first average simulation cycle count to the second average simulation cycle count; and
for each of the plurality of unique testcases for which the simulation cycle count difference exceeds a threshold value, outputting an identifier for the unique testcase and the simulation cycle count difference for the unique testcase.

9. The computer system of claim 8, wherein the operations further comprise:
for each of the plurality of unique testcases for which the second average simulation cycle count exceeds the first average simulation cycle count by the threshold value, outputting an indicator indicating that a system regression has occurred between the first system state and the second system state.

10. The computer system of claim 8, wherein the operations further comprise:
for each of the plurality of unique testcases for which the first average simulation cycle count exceeds the second average simulation cycle count by the threshold value, outputting an indicator indicating that a system performance improvement has occurred between the first system state and the second system state.

11. The computer system of claim 8, wherein the first system state and the second system state are system states between model release tags.

12. The computer system of claim 8, wherein the determining the simulation cycle count difference by comparing the first average simulation cycle count to the second average simulation cycle count comprises:
comparing the first average simulation cycle count to the second average simulation cycle count only for unique testcases that pass simulation testing.

13. The computer system of claim 8, wherein the determining the simulation cycle count difference by comparing the first average simulation cycle count to the second average simulation cycle count comprises:
comparing the first average simulation cycle count to the second average simulation cycle count for at least a specified threshold number of unique testcases.

14. The computer system of claim 8, wherein the threshold value for the simulation cycle count difference is a user specified threshold value.

15. A computer program product, comprising:
one or more computer-readable storage media; and
program instructions stored on the one or more storage media to perform operations comprising:
determining a first average simulation cycle count for running each of a plurality of unique testcases in a first system state;
determining a second average simulation cycle count for running each of the plurality of unique testcases in a second system state;
for each of the plurality of unique testcases, determining a simulation cycle count difference by comparing the first average simulation cycle count to the second average simulation cycle count; and
for each of the plurality of unique testcases for which the simulation cycle count difference exceeds a threshold value, outputting an identifier for the unique testcase and the simulation cycle count difference for the unique testcase.

16. The computer program product of claim 15, wherein the operations further comprise:
for each of the plurality of unique testcases for which the second average simulation cycle count exceeds the first average simulation cycle count by the threshold value, outputting an indicator indicating that a system regression has occurred between the first system state and the second system state.

17. The computer program product of claim 15, wherein the operations further comprise:
for each of the plurality of unique testcases for which the first average simulation cycle count exceeds the second average simulation cycle count by the threshold value, outputting an indicator indicating that a system performance improvement has occurred between the first system state and the second system state.

18. The computer program product of claim 15, wherein the first system state and the second system state are system states between model release tags.

19. The computer program product of claim 15, wherein the determining the simulation cycle count difference by comparing the first average simulation cycle count to the second average simulation cycle count comprises:
comparing the first average simulation cycle count to the second average simulation cycle count only for unique testcases that pass simulation testing.

20. The computer program product of claim 15, wherein the determining the simulation cycle count difference by comparing the first average simulation cycle count to the second average simulation cycle count comprises:
comparing the first average simulation cycle count to the second average simulation cycle count for at least a specified threshold number of unique testcases.
